(19) United States
(12) Patent Application Publication
(10) Pub. No.: US 2026/0074096 A1
(43) Pub. Date: Mar. 12, 2026

(54) GUARD FOR WIDE ARRANGEMENT CONDUCTOR CONFIGURATIONS

(71) Applicant: Hubbell Incorporated, Shelton, CT (US)

(72) Inventors: Paul Alfaro, JR., Orange, CA (US); Joseph Alfaro, Artesia, CA (US)

(21) Appl. No.: 19/323,046

(22) Filed: Sep. 9, 2025

Related U.S. Application Data
(60) Provisional application No. 63/692,404, filed on Sep. 9, 2024.

(51) Int. Cl. H01B 17/40; H01B 17/26; H01B 17/58; H02G 1/02

(52) U.S. Cl. CPC H01B 17/40; H01B 17/26; H01B 17/583; H02G 1/02

(57) ABSTRACT

The clamp guard includes a first body and a second body. The first body includes a first upper end, a first lower end, and a first axis extending between the first upper end and the first lower end. The first body includes a first connection feature disposed proximate to the first upper end. The second body includes a second upper end, a second lower end, and a second axis extending between the second upper end and the second lower end. The second body includes a second connection feature disposed proximate to the second upper end. The first connection feature is connected to the second connection feature along a pivot axis. The pivot axis is oriented at an oblique angle relative to the first axis and the second axis. The first body can pivot relative to the second body about the pivot axis between an open position and a closed position.

### CROSS-REFERENCE TO RELATED APPLICATION

The application claims priority to U.S. Provisional Application No. 63/692,404, filed Sep. 9, 2024, the entire contents of which is incorporated herein by reference in its entirety.

### FIELD

The present disclosure relates to a clamp. More particularly, the present disclosure relates to a clamp guard for use with components connected to an electrical conductor.

### BACKGROUND

Electrical components (e.g., power lines and other energized elements) are built across different environments to bring power to consumers and businesses. To convey electrical energy to consumers across wide and diverse areas, energized components need to be built within many environments, some of may be undeveloped or otherwise include an abundance of wildlife. Wildlife may be interested in these structures and not realize the dangers posed by the energized elements. Additionally, or alternatively, wildlife may attempt to interact with the components in ways that are harmful to the life of the component.

To keep wildlife safe and/or to extent the lifespan of the electrical components, linesman or other technicians may install guards at or near the energized elements. These guards may assist in providing a barrier between the animals'habitat and the energized elements, thereby reducing the animals that are inadvertently harmed and the components from being damaged. The guards also help to maintain the integrity of the system by limiting shorts or other electrical failures caused when animals interact with the energized elements.

Typical guards require the linesman or technician to physically close the guard around the desired element. Additionally, the guard may not fully enclose the element and may still provide pathways for wildlife to enter and interact with the component.

Furthermore, the direction of motion of a guard may limit the orientation of the electrical components connected in the guard or may require the guard to be disassembled and reassembled to be positioned around electrical devices with certain orientations.

### SUMMARY

Various embodiments of the present disclosure can overcome various of the aforementioned and other disadvantages associated with known clamps and offer new advantages as well.

According to one aspect of various embodiments of the present disclosure there is provided a clamp guard for selectively limiting ingress to an internal cavity of the clamp guard.

According to one aspect of various embodiments of the present disclosure there is provided a clamp guard that pivots between an open position and a closed position.

According to one aspect of various embodiments of the present disclosure there is provided a clamp guard with a first body and a second body. The first body can pivot relative to the second body along a pivot axis that is oblique relative to a height of the first body.

According to another aspect of various embodiments of the present disclosure, there is provided a clamp guard for securing an electrical component. The clamp guard includes a first body and a second body. The first body includes a first upper end and a first lower end and a first axis extending between the first upper end and the first lower end. The first body also includes a first connection feature disposed proximate to the first upper end. The second body includes a second upper end and a second lower end and a second axis extending between the second upper end and the second lower end. The second body also includes a second connection feature disposed proximate to the second upper end. The first connection feature is connected to the second connection feature along a pivot axis. The pivot axis is oriented at an oblique angle relative to the first axis and the second axis. The first body can pivot relative to the second body about the pivot axis between an open position and a closed position.

According to another aspect of various embodiments of the present disclosure, there is provided clamp guard for securing an electrical component. The clamp guard includes a first body and a second body. The first body includes a first upper end, a first lower end, and a first edge extending between the first upper and first lower edge. A first cavity can at least partially receive an electrical device. A first connection feature is disposed proximate to the first upper end. The second body includes a second upper end, a second lower end, and a second edge extending between the second upper and second lower edge. A second cavity can at least partially receive the electrical device. A second connection feature disposed proximate to the second upper end. The first body can pivot about a pivot axis relative to the second body between an open position and a closed position. The pivot axis is oriented at an oblique angle relative to the first edge and the second edge in the closed position. The first connection feature can engage the second connection feature to selectively secure the first body and the second body in the closed position.

According to another aspect of various embodiments of the present disclosure, there is provided a method for pivoting a clamp enclosure between an open position and a closed position while the clamp guard at least partially surrounds an electrical component.

According to another aspect of various embodiments of the present disclosure, there is provided a method for securing a clamp guard to an electrical component. The method includes connecting a first body to a second body, and pivoting the first body relative to the second body about a pivot axis to an open position. The method also includes positioning the electrical component within a cavity of the second body along an insertion axis that is oriented at an oblique angle relative to the pivot axis. The method also includes pivoting the first body relative to the second body about the pivot axis to a closed position. The first body and the second body at least partially surround the electrical component.

In some forms, there is a method for securing a clamp guard to an electrical component. A first connection feature of a first body is connected to a second connection feature of a second body with a snap fit. The first connection feature is pivoted relative to the second connection feature about a pivot axis to an open position to at least partially expose a first cavity of the first body and a second cavity of the second body. The electrical component is positioned within the second cavity, wherein the electrical component extends along a component axis perpendicular to an insertion axis and obliquely oriented with respect to the pivot axis. The first body is pivoted relative to the second body about the pivot axis to a closed position, wherein the electrical component is at least partially received within the first cavity and the second cavity.

The disclosure herein should become evident to a person of ordinary skill in the art given the following enabling description and drawings. The drawings are for illustration purposes only and are not drawn to scale unless otherwise indicated. The drawings are not intended to limit the scope of the invention. The following enabling disclosure is directed to one of ordinary skill in the art and presupposes that those aspects within the ability of the ordinarily skilled artisan are understood and appreciated.

### BRIEF DESCRIPTION OF THE DRAWINGS:

Various aspects and advantageous features of the present disclosure will become more apparent to those of ordinary skill when described in the detailed description of preferred embodiments and reference to the accompany drawing wherein:

FIG. 1 is a perspective view of an enclosure in a closed position.

FIG. 2 is a front view of the enclosure of FIG. 1.

FIG. 3 is a side view of the enclosure of FIG. 1.

FIG. 4 is a top view of the enclosure of FIG. 1.

FIG. 5 is a bottom view of the enclosure of FIG. 1.

FIG. 6 is a cross-sectional view of the enclosure of FIG. 1, viewed along section 6-6.

FIG. 7 is a perspective view of a first section of the enclosure of FIG. 1.

FIG. 8 is a front view of the first section of FIG. 7.

FIG. 9 is a perspective view of a second section of the enclosure of FIG. 1.

FIG. 10 is a front view of the second section of FIG. 9.

FIG. 11 is a perspective view of the enclosure of FIG. 1 in an open position.

FIG. 12 is a front view of the enclosure of FIG. 11.

FIG. 13 is a side view of the enclosure of FIG. 11.

FIG. 14 is a front perspective view of the enclosure partially connected to an electrical device.

FIG. 15 is a rear perspective view of the enclosure of FIG. 14.

FIG. 16 is a front view of the enclosure of FIG. 14.

FIG. 17 is a perspective view of the enclosure of FIG. 1 connected to the electrical device with connectors disposed in a first orientation.

FIG. 18 is a perspective view of the enclosure of FIG. 1 connected to the electrical device with connectors disposed in a second orientation.

FIG. 19 is a perspective view of an alternate enclosure.

### DETAILED DESCRIPTION:

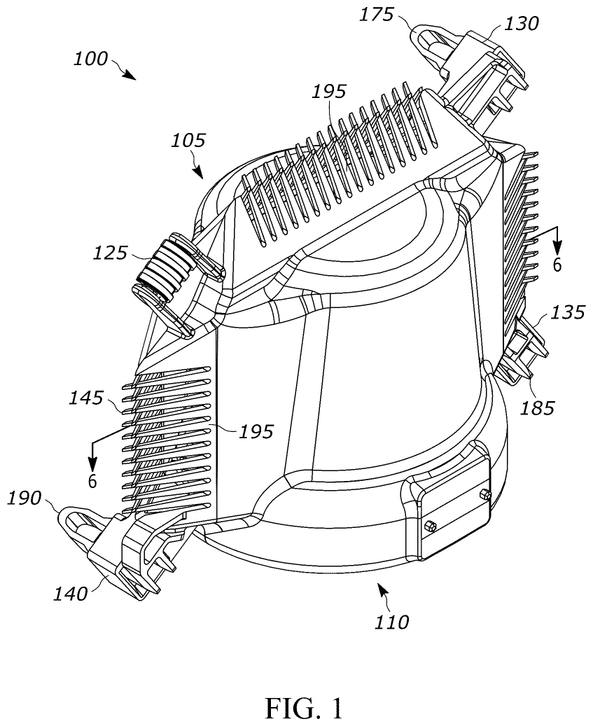

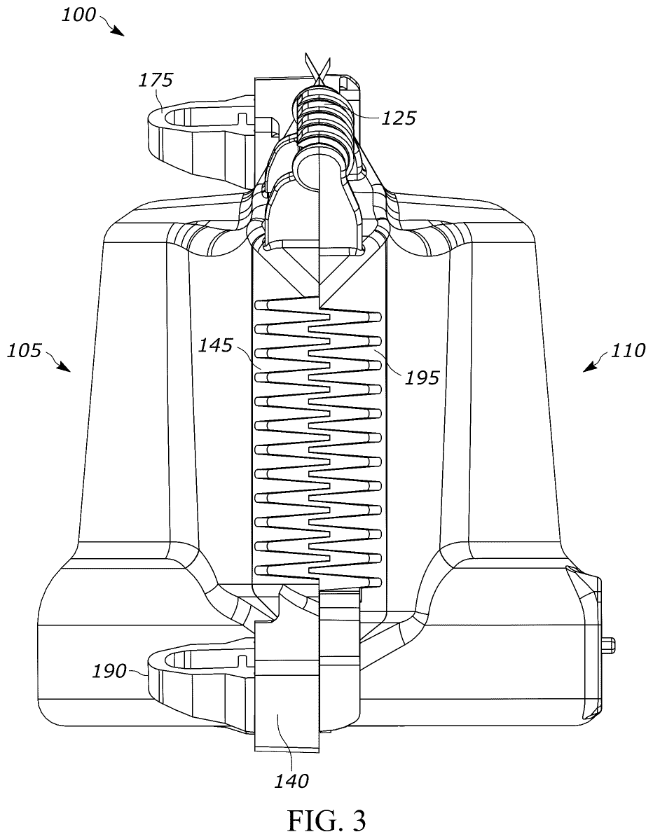

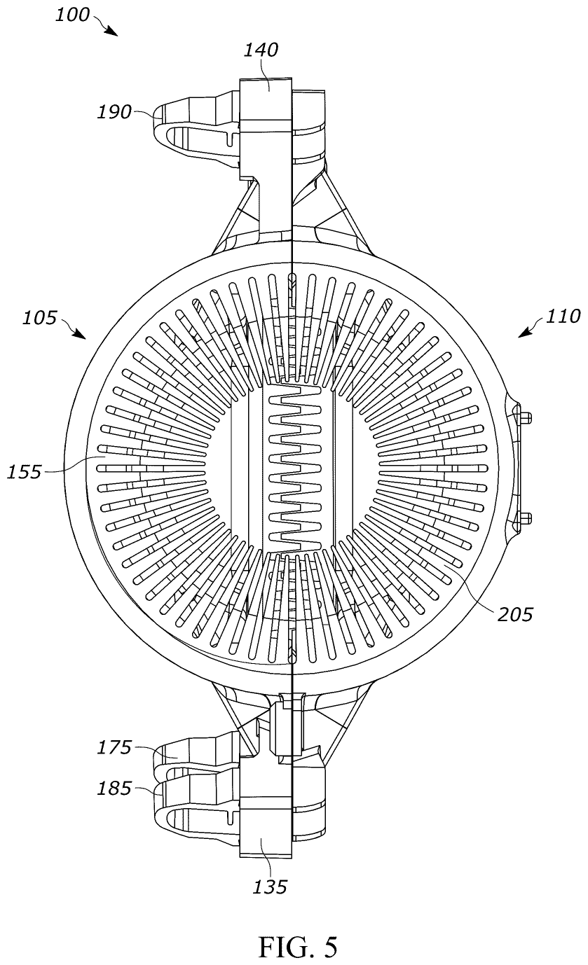

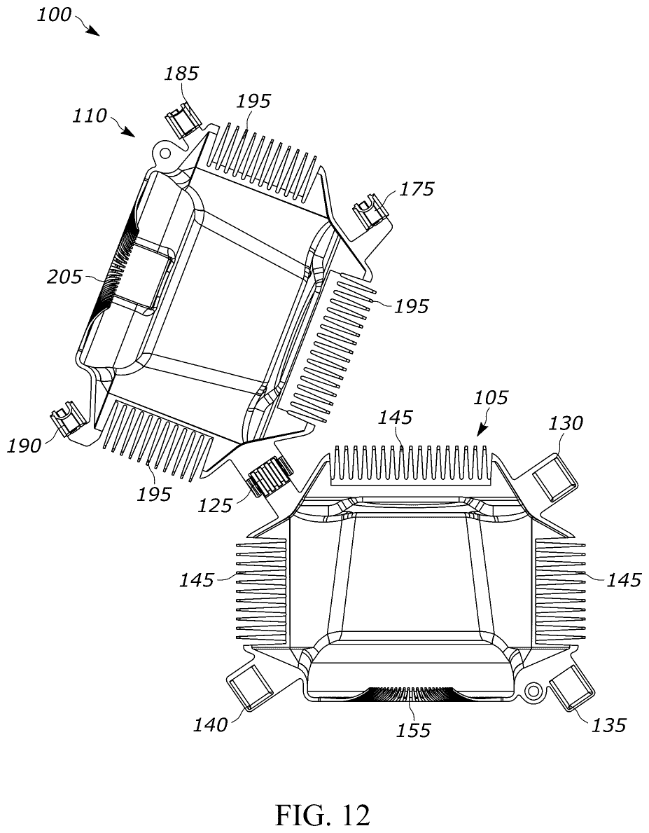

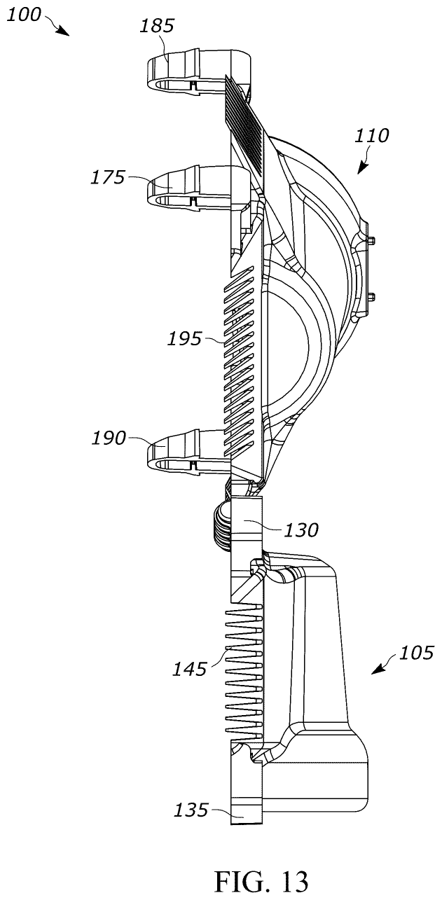

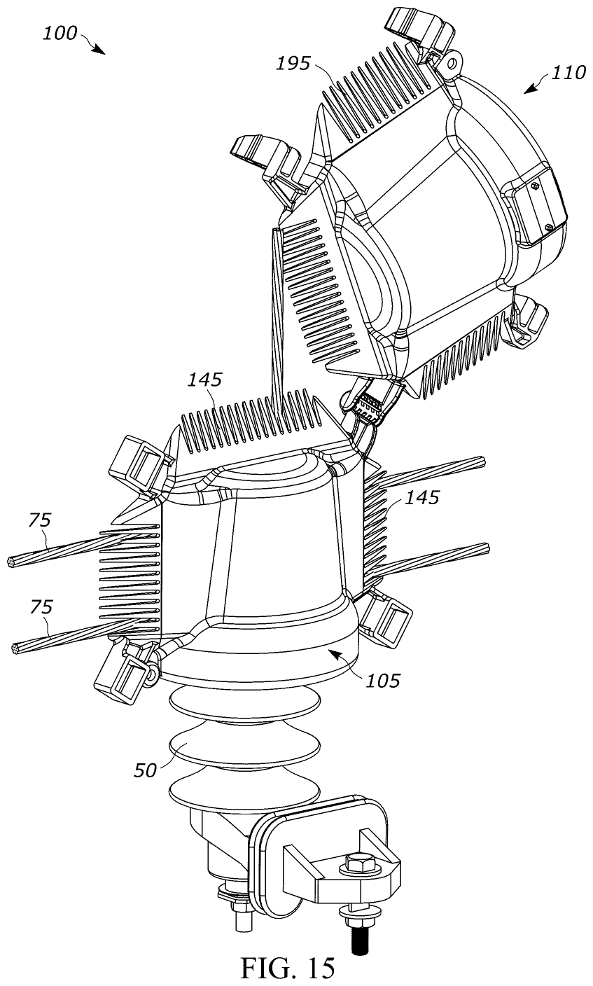

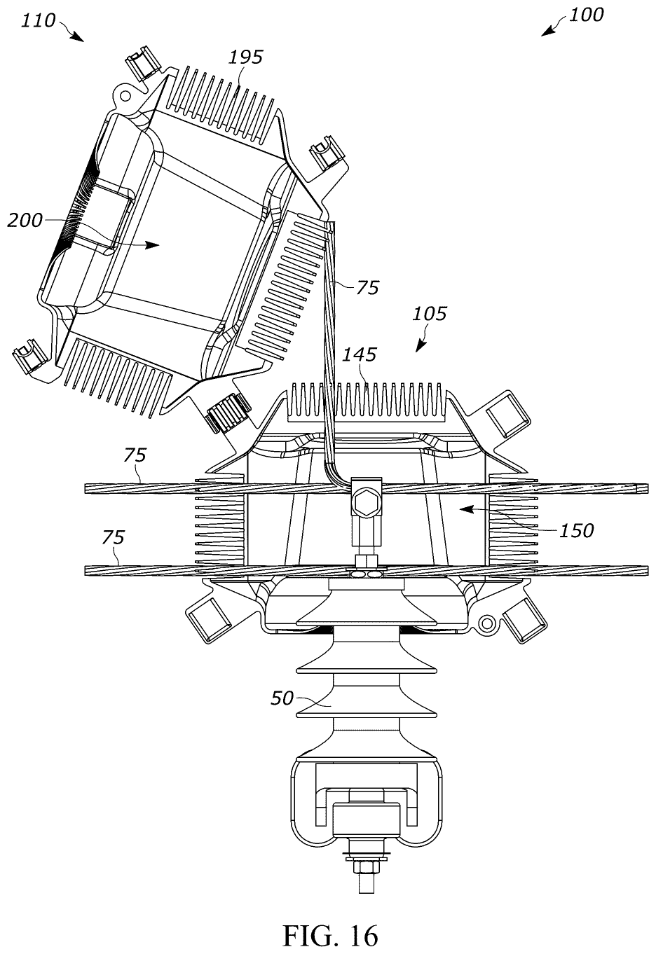

FIGS. 1 to 18 illustrate a housing, enclosure, or clamp guard 100 that may be used to house electrical components. Specifically, the clamp guard 100 may limit access to energized components from avian and climbing animals by creating a physical barrier to impede access.

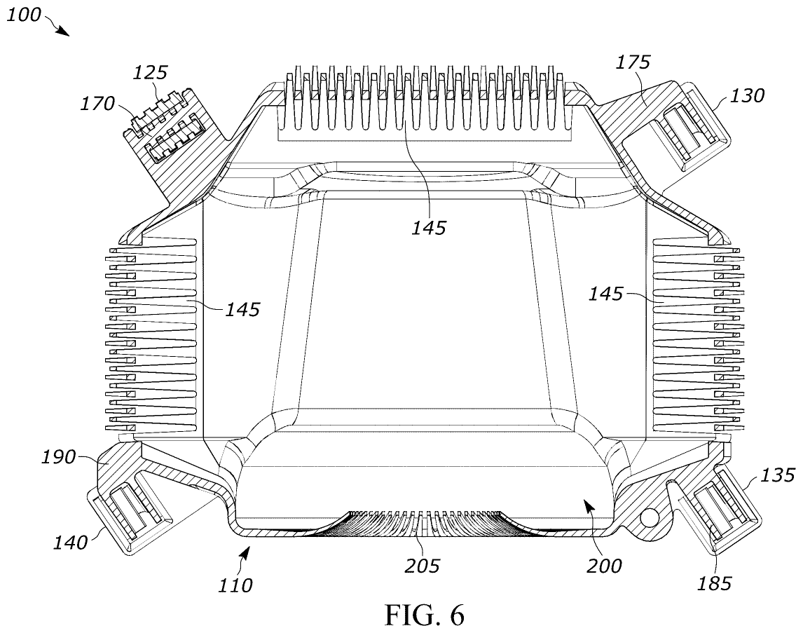

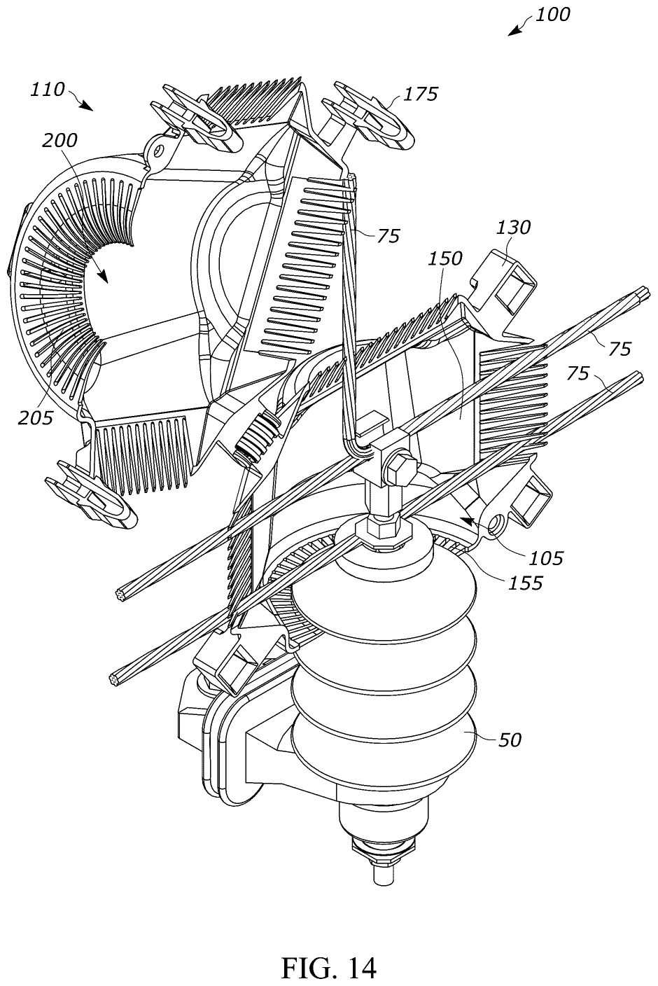

As shown in FIGS. 1 to 5, the clamp guard 100 may be formed form a first body or shell 105 and a second body or shell 110. The first and second shells 105, 110 may at least partially form an internal volume (see e.g., FIG. 6) that can house an electrical component (see e.g., FIGS. 14 to 17). In some forms, the first and second bodies 105, 110 may be substantially similar in shape to one another.

For example, other instances of the first body 105 (not shown) may be substantially identical to the second body 110. This may assist in manufacturing where one part can be manufactured (e.g., molded) to form two elements.

The first body 105 may include an upper end 115 and a lower end 120. The terms upper and lower may be used in relation to the orientation shown in FIG. 1 and may not restrict the orientation of the clamp guard 100 while in use.

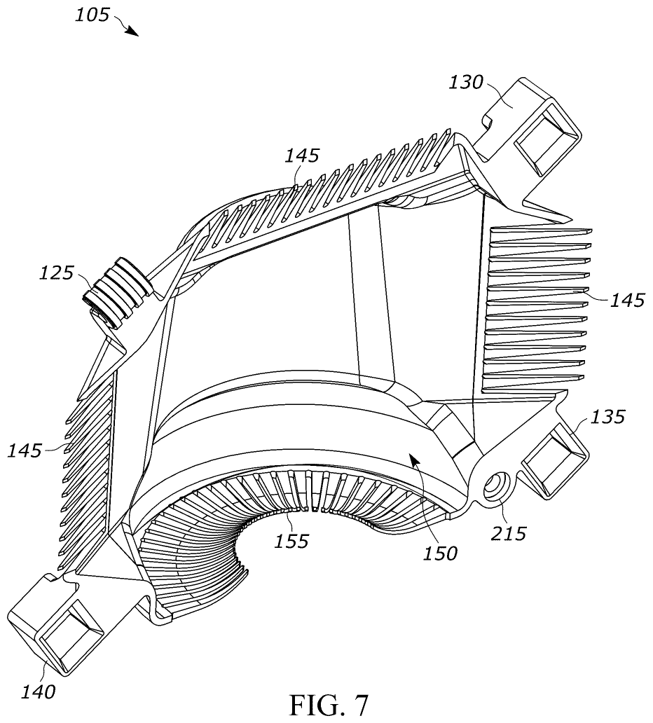

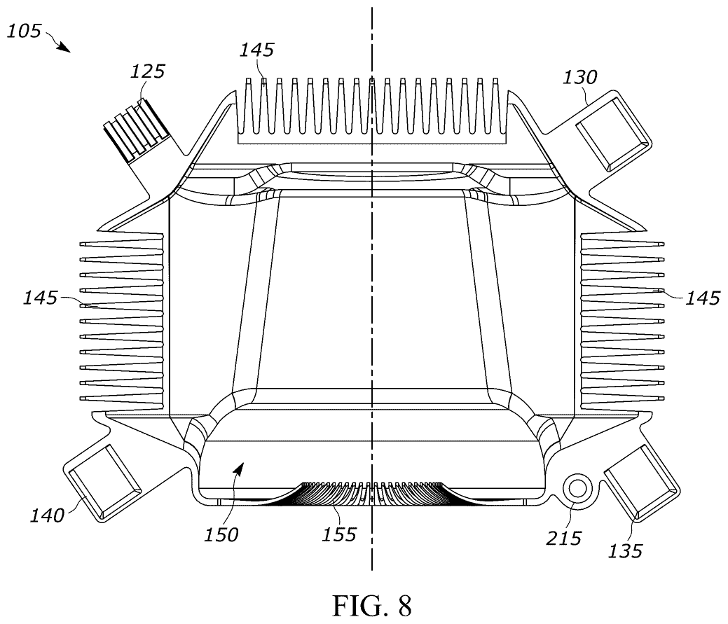

As shown in FIGS. 7 and 8, the upper end 115 of the first body 105 may include a first connection feature 125 and a second connection feature 130 spaced apart from the first connection feature 125. In the illustrated example, the first connection feature 125 and the second connection feature 130 have different shapes, although in other examples, the first and second connection features 125, 130 may be the same shape.

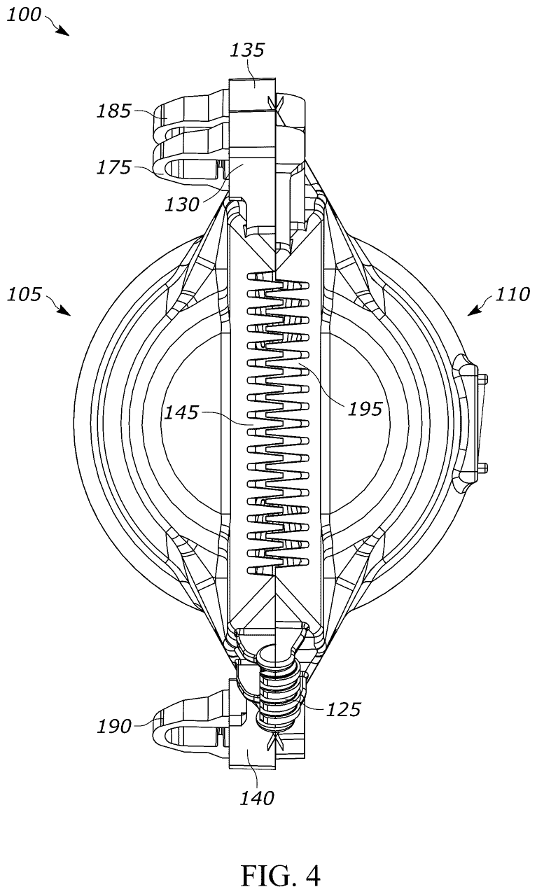

For example, the first connection feature 125 may be a hook or C-shaped feature. The hook 125 may be oriented in a concave outwardly direction (e.g., away from the second body 110 as shown in FIG. 4). However, other examples of the first connection feature 125 may be an elongated body (e.g., a substantially cylindrical shape) with a complementary shape to the concave region.

In some forms, the second connection feature 130 may be different than the first connection feature 125. For example, the illustrated second connection feature 130 may be an opening (e.g., a loop). As described in more detail below, the second connection feature 130 may be sized and shaped to receive a male latch.

In certain forms, the second connection feature 130 may be substantially rectangular in shape and may include a substantially rectangularly shaped opening. However, other examples may include any other shapes (e.g., circular, elliptical, triangular, etc.).

In certain forms, the first connection feature 125 and the second connection feature 130 may extend from the upper end 115 of the first body 105 at substantially the same angle. For example, the first connection feature 125 and the second connection feature 130 may extend at an angle between about 1 degree and about 90 degrees. In some forms, the first connection feature 125 and the second connection feature 130 may extend at an angle between about 5 degrees and about 75 degrees. In some forms, the first connection feature 125 and the second connection feature 130 may extend at an angle between about 10 degrees and about 60 degrees. In some forms, the first connection feature 125 and the second connection feature 130 may extend at an angle between about 30 degrees and about 50 degrees.

With continued reference to FIGS. 7 and 8, the lower end 120 of the first body 105 may include a third connection feature 135 and a fourth connection feature 140 spaced apart from the third connection feature 135. In the illustrated example, the third connection feature 135 and the fourth connection feature 140 may have the same shape, although in other examples, the third and fourth connection features 135, 140 may be a different shape.

In certain forms, the third and fourth connection features 135, 140 may have the same shape as the second connection feature 130. For example, the third and fourth connection features 135, 140 may be an opening (e.g., a rectangularly shaped opening). Although in other examples, the third connection feature 135 and/or the fourth connection feature 140 may have a different shape or a different type of connector (e.g., a male connector instead of a female connector).

In certain forms, the third connection feature 135 and the fourth connection feature 140 may extend from the lower end 120 of the first body 105 at substantially the same angle. For example, the third connection feature 135 and the fourth connection feature 140 may extend at an angle between about 1 degree and about 90 degrees. In some forms, the third connection feature 135 and the fourth connection feature 140 may extend at an angle between about 5 degrees and about 75 degrees. In some forms, the third connection feature 135 and the fourth connection feature 140 may extend at an angle between about 10 degrees and about 60 degrees. In some forms, the third connection feature 135 and the fourth connection feature 140 may extend at an angle between about 30 degrees and about 50 degrees.

In the illustrated example, the first body 105 may include fingers 145 at least partially along one or more sides of the body. Each finger 145 may be formed as a cantilever member (e.g., with a fixed end and a free end). Each cantilever finger 145 may be tapered so that a distance between adjacent free ends is greater than a distance between adjacent fixed ends.

In some forms, the fingers 145 may be constructed from a flexible material and/or may be sized to permit flexion. As described in more detail below, the fingers 145 may be able to bend and/or flex to permit ingress and/or egress from the clamp guard 100.

As shown in FIGS. 7 and 8, a plurality of fingers 145 may be formed between the first and second connection features 125, 130. For example, the plurality of fingers 145 may be formed in a center of an edge between the first and second connection features 125, 130 and may be spaced apart from the first and second connection features 125, 130.

In some forms, additional pluralities of fingers 145 may be formed between the first and third connection features 125, 135 and/or between the second and fourth connection features 130, 140. These fingers 145 may be similarly positioned so that they are approximately centered on the respective side and do not extend entirely between the respective connection features.

As shown in FIG. 7, some forms of the first body 105 may include all of the fingers 145 oriented in substantially the same direction. For example, the fingers 145 in each grouping (e.g., the fingers 145 between the first and second connection features 125, 130) may all be substantially parallel to one another. Furthermore, all of the fingers 145 may extend in a rearward direction on the first body 105. For example, the free end of each finger 145 and the cavity 150 of the first body 105 may be visible in the same direction (see e.g., FIG. 8).

In some forms, fingers 155 may extend between the third and fourth connection features 135, 140. In the illustrated example, the fingers 155 may have at least some dissimilarities than the fingers 145. For example, the fingers 155 may be formed as cantilever members and/or may taper toward a smaller width at the respective free end. However, the fingers 155 may not be oriented in a parallel arrangement like the fingers 145. Instead, the fingers 155 may be oriented in a substantially curved orientation. For example, the fingers 155 may be arranged in a semi-circular orientation, although any curved orientation (e.g., elliptical) can be used.

In certain forms, one of more of the fingers 155 (e.g., all of the fingers 155 shown) may be curved along its length. For example, each finger 155 may not reside in a single plane along its length between the fixed end and the free end. The free end of the illustrated fingers 155 may curve upwardly (e.g., toward the upper end 115). As described in more detail below, the curvature of the fingers 155 may assist in providing consistent compression during installation.

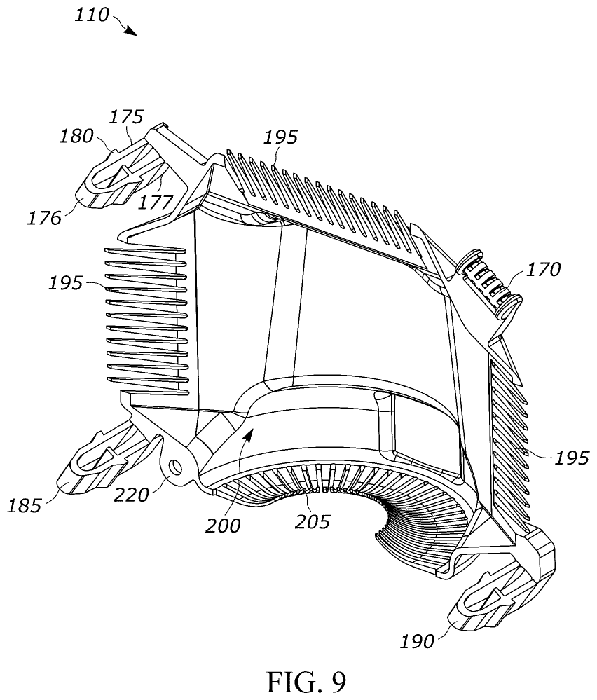

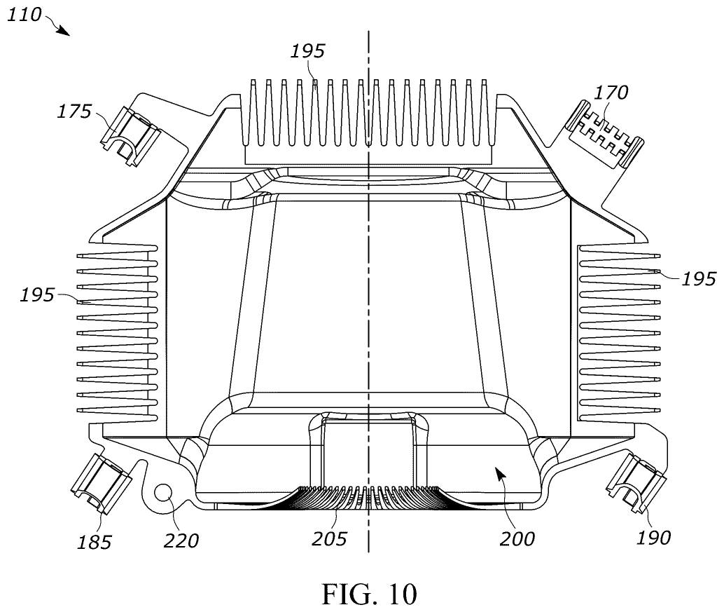

As shown in FIGS. 9 and 10, the second body 110 may include an upper end 160 and a lower end 165. The terms upper and lower may be used in relation to the orientation shown in FIG. 1 and may not restrict the orientation of the clamp guard 100 while in use.

As shown in FIGS. 9 and 10, the upper end 160 of the second body 110 may include a first connection feature 170 and a second connection feature 175 spaced apart from the first connection feature 170. In the illustrated example, the first connection feature 170 and the second connection feature 175 have different shapes, although in other examples, the first and second connection features 170, 175 may be the same shape.

For example, the first connection feature 170 may have a substantially cylindrical shape. As described in more detail below, the first connection feature 170 of the second body 110 may be sized and shaped to be received by the first connection feature 125 of the first body 105. As described above, alternate examples may include the first connection feature 170 of the second body 110 with a hook or C-shaped feature.

In some forms, the second connection feature 175 may be different than the first connection feature 170. For example, the illustrated second connection feature 175 may be a projection. As described in more detail below, the second connection feature 175 may be sized and shaped to be received in a female latch (e.g., the second connection feature 130).

In certain forms, the second connection feature 175 may be formed as an elongated member with a first end 176 and a second end 177. The second connection feature 175 may be formed as a substantially U-shaped body between the first and second ends 176, 177. For example, the first end 176 may be curved and the second end 177 may be open. This may provide for a space between the walls of the second connection feature 175 between the first and second ends 176, 177.

In certain forms, the second connection feature 175 may include one or more protrusions 180 (e.g., a ramped protrusion—two shown) formed between the first and second ends 176, 177. The protrusions 180 may be formed on an outer surface of the second connection feature 175. The protrusions 180 may be formed opposite one another across the body.

In certain forms, the first connection feature 170 and the second connection feature 175 may extend from the upper end 160 of the second body 110 at substantially the same angle. For example, the first connection feature 170 and the second connection feature 175 may extend at an angle between about 1 degree and about 90 degrees. In some forms, the first connection feature 170 and the second connection feature 175 may extend at an angle between about 5 degrees and about 75 degrees. In some forms, the first connection feature 170 and the second connection feature 175 may extend at an angle between about 10 degrees and about 60 degrees. In some forms, the first connection feature 170 and the second connection feature 175 may extend at an angle between about 30 degrees and about 50 degrees.

With continued reference to FIGS. 9 and 10, the lower end 165 of the second body 110 may include a third connection feature 185 and a fourth connection feature 190 spaced apart from the third connection feature 185. In the illustrated example, the third connection feature 185 and the fourth connection feature 190 may have the same shape, although in other examples, the third and fourth connection features 185, 190 may be a different shape.

In certain forms, the third and fourth connection features 185, 190 may have the same shape as the second connection feature 175. For example, the third and fourth connection features 185, 190 may be a male latch (e.g., an elongated member). Although in other examples, the third connection feature 185 and/or the fourth connection feature 190 may have a different shape or a different type of connector (e.g., a female connector instead of a male connector).

In certain forms, the third connection feature 185 and the fourth connection feature 190 may extend from the lower end 165 of the second body 110 at substantially the same angle. For example, the third connection feature 185 and the fourth connection feature 190 may extend at an angle between about 1 degree and about 90 degrees. In some forms, the third connection feature 185 and the fourth connection feature 190 may extend at an angle between about 5 degrees and about 75 degrees. In some forms, the third connection feature 185 and the fourth connection feature 190 may extend at an angle between about 10 degrees and about 60 degrees. In some forms, the third connection feature 185 and the fourth connection feature 190 may extend at an angle between about 30 degrees and about 50 degrees.

In the illustrated example, the second body 110 may include fingers 195 at least partially along one or more sides of the body. Each finger 195 may be formed as a cantilever member (e.g., with a fixed end and a free end). Each cantilever finger 195 may be tapered so that a distance between adjacent free ends is greater than a distance between adjacent fixed ends.

In some forms, the fingers 195 may be constructed from a flexible material and/or may be sized to permit flexion. As described in more detail below, the fingers 195 may be able to bend and/or flex to permit ingress and/or egress from the clamp guard 100.

As shown in FIGS. 9 and 10, a plurality of fingers 195 may be formed between the first and second connection features 170, 175. For example, the plurality of fingers 195 may be formed in a center of an edge between the first and second connection features 170, 175 and may be spaced apart from the first and second connection features 170, 175.

In some forms, additional pluralities of fingers 195 may be formed between the first and third connection features 170, 185 and/or between the second and fourth connection features 175, 190. These fingers 195 may be similarly positioned so that they are approximately centered on the respective side and do not extend entirely between the respective connection features.

As shown in FIG. 9, some forms of the second body 110 may include all of the fingers 195 oriented in substantially the same direction. For example, the fingers 195 in each grouping (e.g., the fingers 195 between the first and second connection features 170, 175) may all be substantially parallel to one another. Furthermore, all of the fingers 195 may extend in a rearward direction on the second body 110. For example, the free end of each finger 195 and the cavity 200 of the second body 110 may be visible in the same direction (see e.g., FIG. 10).

In some forms, fingers 205 may extend between the third and fourth connection features 185, 190. In the illustrated example, the fingers 205 may have at least some dissimilarities than the fingers 195. For example, the fingers 205 may be formed as cantilever members and/or may taper toward a smaller width at the respective free end. However, the fingers 205 may not be oriented in a parallel arrangement like the fingers 195. Instead, the fingers 205 may be oriented in a substantially curved orientation. For example, the fingers 205 may be arranged in a semi-circular orientation, although any curved orientation (e.g., elliptical) can be used.

In certain forms, one of more of the fingers 205 (e.g., all of the fingers 205 shown) may be curved along its length. For example, each finger 205 may not reside in a single plane along its length between the fixed end and the free end. The free end of the illustrated fingers 205 may curve upwardly (e.g., toward the upper end 160). As described in more detail below, the curvature of the fingers 205 may assist in providing consistent compression during installation.

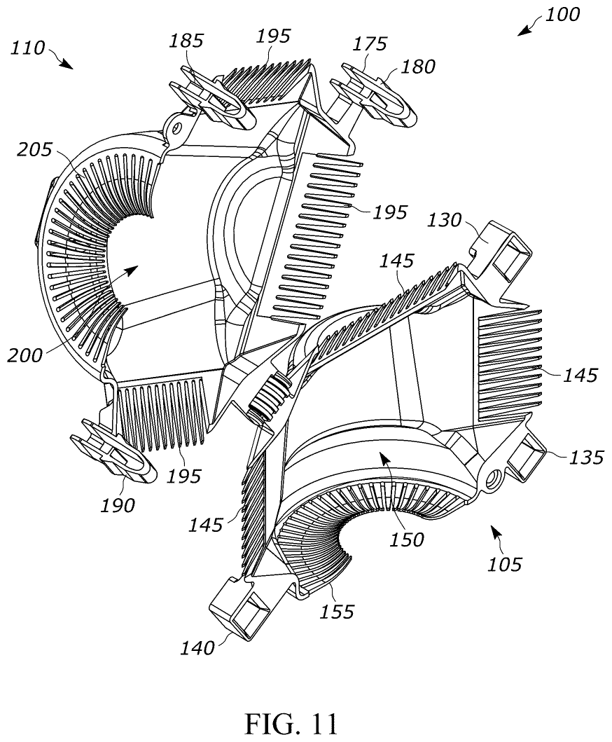

As show in FIGS. 1 to 6, the first and second bodies 105, 110 may be connected to one another. For example, the first connection feature 125 of the first body 105 may be connected to the first connection feature 170 of the second body 110. When connected, the first body 105 and the second body 110 may movable relative to one another between a closed position (see e.g., FIG. 1) and an open position (see e.g., FIG. 11).

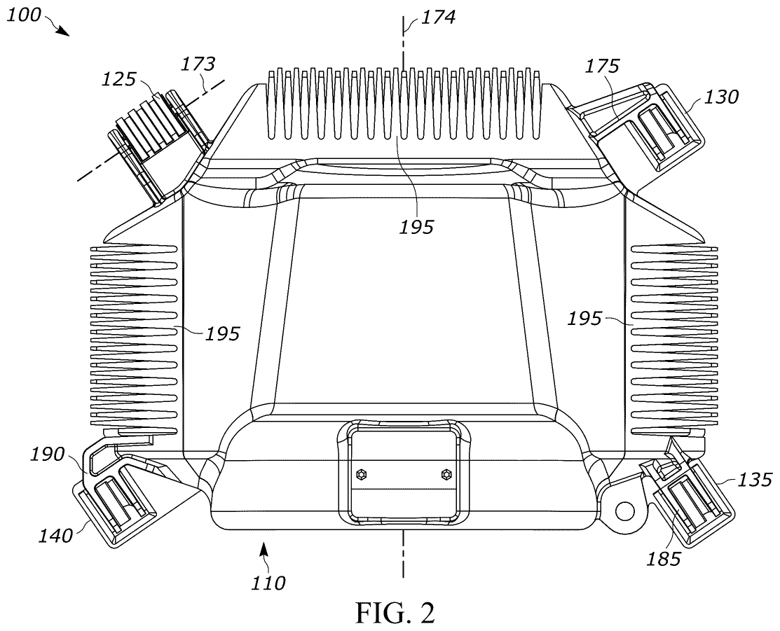

In some forms, the first body 105 and the second body 110 may pivot relative to one another. For example, the first body 105 may pivot away from the second body 105 about the axis 173 of the first connection features 125, 170. As described above, the first connection features 125, 170 are respectively oriented at an angle relative to the respective upper end 115, 160. The first body 105 may therefore pivot along this angled axis 173 when moving between the opening and closed positions. In other words, the first body 105 (or the second body 110) may not pivot along a horizontal or vertical axis (e.g., no pivoting movement about vertical axis 174 as oriented in FIG. 2).

As shown in FIG. 11 to 13, the cavity 150 of the first body 105 and the cavity 200 of the second body 110 may be exposed when the clamp guard 100 is in the open position. In this position, a technician may position an object (e.g., an electrical device) within one or both of the cavities 150, 200.

In some forms, the first body 105 may be able to pivot up to at least 60 degrees relative to the second body 110 between the opened and closed positions. In some forms, the first body 105 may be able to pivot up to at least 90 degrees relative to the second body 110 between the opened and closed positions. In some forms, the first body 105 may be able to pivot up to at least 120 degrees relative to the second body 110 between the opened and closed positions. In some forms, the first body 105 may be able to pivot up to at least 180 degrees relative to the second body 110 between the opened and closed positions.

In one form (not shown), a biasing member (e.g., a spring) may be coupled between the first body 105 and the second body 110. The first body 105 may move against the bias of the biasing member when moving between the opened and closed positions.

As shown in FIGS. 14 to 16, multiple electrical components may be positioned within the cavities 150, 200. For example, the clamp guard 100 may be positioned around an electrical bushing 50. In the illustrated example, the bushing 50 has a curved outer perimeter which may be substantially similar to the width of the opening form by the fingers 155, 205. As described in more detail below, the fingers 155, 205 may extend around the perimeter of the bushing 50 to limit ingress (e.g., by climbing animals) into the cavities 150, 200.

In some forms, one or more electrical conductors 75 may be connected to the bushing 50. The electrical conductors 75 may extend beyond the outer width of the bushing 50. The electrical conductors 75 may be oriented so that they are aligned with the fingers 145, 195, and may be able to ingress or egress the cavities 150, 200 through the fingers 145, 195.

When positioning the clamp guard 100, a technician may position one body (e.g., the first body 105 is shown) partially around the bushing 50 where the fingers 155 are aligned with outer surface of the perimeter of the bushing 50 and at least part of the bushing 50 is received within the cavity 150. Additionally, the conductors 75 are positioned to extend proximate each of the groups of fingers 145.

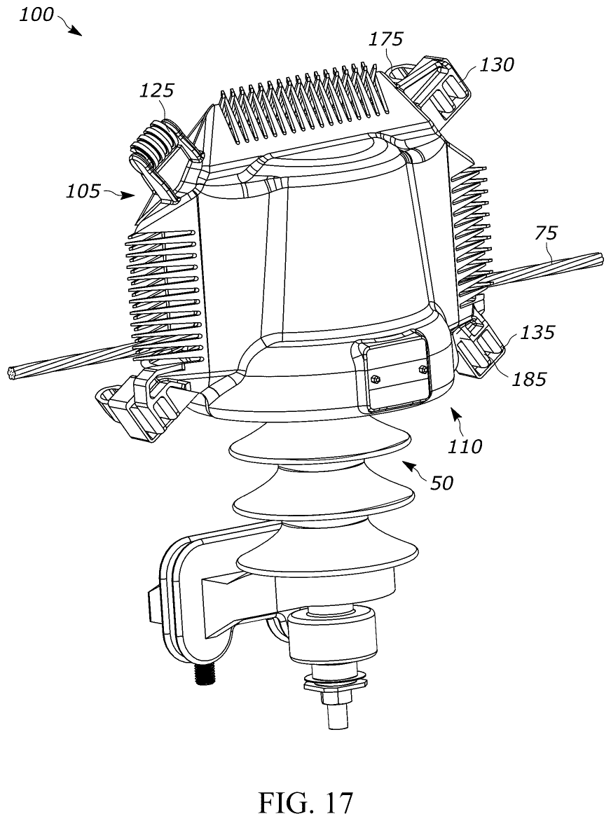

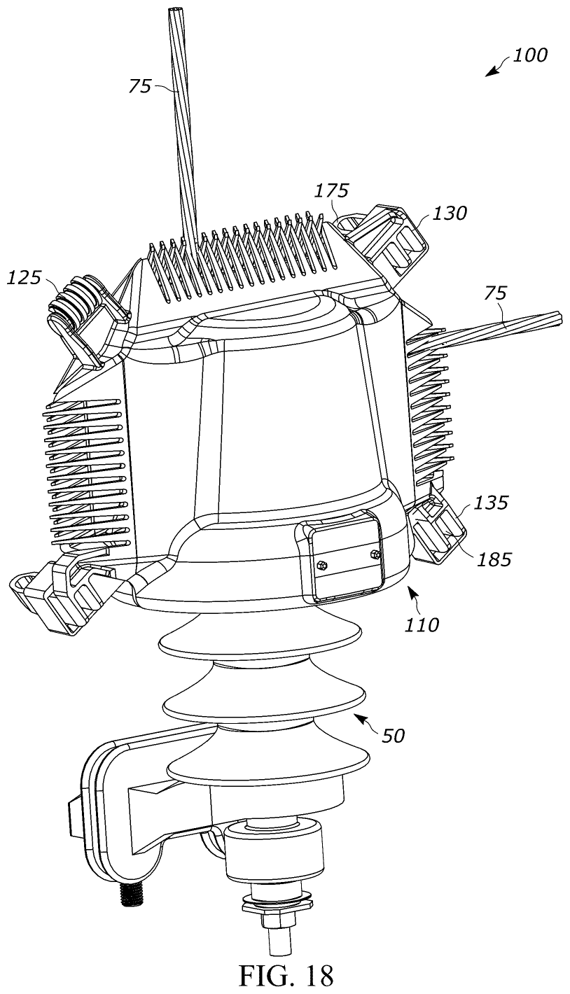

As shown in FIGS. 17 and 18, the technician can then pivot the other body (e.g., the second body 110) toward the first body 105 to enclose the bushing 50. As described above, the axis of rotation 173 is offset from the horizontal and vertical directions. As illustrated, the axis of rotation 173 is oblique relative to the direction of any of the conductors 75. Thus, the second body 110 can pivot between the open and closed positions without interference from the conductors 75. As the second body 110 rotates, it can move freely toward the bushing 50. The fingers 205 may be positioned proximate to the fingers 155 thereby forming a substantially complete perimeter. Additionally, the fingers 195 may move proximate to the fingers 145 to assist in enclosing the cavities 150, 200. The fingers 145, 195 may be resilient to permit the ingress/egress of the conductors 75. For example, the fingers 145, 195 may flex to permit the conductor 75 to pass through. The fingers 145, 195 may be biased toward their neutral position to limit ingress of animals and/or debris even when a conductor 75 is extending out of the clamp guard 100.

In some forms, the fingers 145, 195 may be interlaced when the enclosure 100 is in the closed position. For example, each finger 145 may be positioned between adjacent fingers 195 in the closed position. The interlaced fingers 145, 195 may reduce the gaps between the fingers 145, 195, and thereby limit access to the cavities 150, 200 from animals and/or debris. The interlaced fingers 145, 195 in contract with an egressing electrical conductor may flex out of the way as described above.

In other forms (not shown), the fingers 145, 195 may not be interlaced with each other. For example, each finger 145 of the first body 105 may be aligned with a respective finger 195 of the second body 110. The fingers 145, 195 on each respective body 105, 110 may be disposed closer together (e.g., than the examples illustrated in FIGS. 1 to 18) to assist in limiting the ingress of animals and/or debris. The fingers 145, 195 may similarly flex away to permit the egress of the electrical conductors.

In still other forms (not shown), the fingers 145 of the first body 105 may be offset from the fingers 195 of the second body 110. However, the fingers 145, 195 may not be interlaced with each other.

In some forms, the curved geometry of the fingers 155, 205 may be pre-biased (e.g., away from the respective upper end 115, 160) to provide a substantially consistent compression. The installed electrical device may push the fingers 155, 205 against this bias so that the fingers 155, 205 remain substantially in contact with the electrical device to limit unintended ingress into the internal cavities.

In some forms, the curved shape of the fingers 155, 205 may be shaped to limit movement (e.g., rattling) of the electrical device against the enclosure 100. For example, the electrical device may be constructed from a softer durometer polymer surface, which could be scratched or otherwise damaged from relative movement between the enclosure 100 and the electrical device.

Returning to FIGS. 1 to 6, the clamp guard 100 may be secured in the closed position to limit inadvertent opening. Specifically, the connection features may be structured to secure the second body 110 relative to the first body 105 in the closed position. For example, each male connection feature on the second body 110 (i.e., the second, third, and fourth connection features 175, 185, 190) may be selectively received within the respective female connection feature of the first body (i.e., the second, third, and fourth connection features 130, 135, 140).

In some forms, each male connection feature may be received within each female connection feature with a snap fit. For example, each male connection feature may be sized to permit entry into the respective female connection feature as the second body 110 rotates toward the first body 105. The ramped protrusion(s) 180 on each male connector may move entirely through the respective female connector. Once the ramped protrusion(s) has passed through, it may limit the movement of the second body 110 away from the first body 105.

In certain forms, the first body 105 may include a first aperture 215 and the second body 110 may include a second aperture 220 that may be aligned with the first aperture 215 in the closed position. A fastener (e.g., a screw, a zip tie, etc.) may be inserted through the first and second apertures 215, 220 to provide additional resistance to movement between the first and second bodies 105, 110.

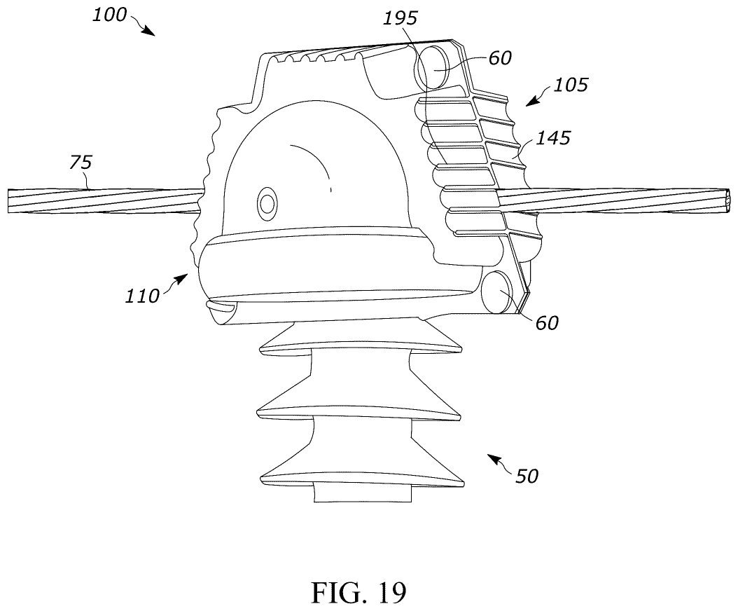

In another form shown in FIG. 19, one or more of the connection features (e.g., all of the connection features) could be related with one or more fasteners. For example, the first and second bodies 105, 110 may be completely separable, and a fastener 60 (e.g., a nylon push fastener) may be used at each corner to connect the first and second bodies 105, 110 together. Alternatively, the first and second bodies 105, 110 may remain pivotably connected, but the second, third, and fourth connection features may be replaced with fasteners 60.

To decouple the male and female connection features, a technician may apply a force to each respective male connection feature. For example, the force could be applied proximate to the respective first end 176. The application of the force (e.g., squeezing at the first end 176) may decrease the width of the male connection feature. This may permit the protrusion 180 to fit through the respective female connection feature. The technician can perform this step one each male connection feature and can then move the second body 110 toward the open position. Because the pivot axis 173 is inclined, the technician is not required to decouple the first connection features 125, 170 from one another when moving the clamp guard 100 to the open position. This may facilitate more efficient opening and closing of the clamp guard 100.

In other examples, the male and female connection features may be replaced with other types of connection features. For example, the first and second bodies 105, 110 may include magnets for selectively securing the clamp guard in the closed position.

One of ordinary skill will appreciate that the exact dimensions and materials are not critical to the disclosure and all suitable variations should be deemed to be within the scope of the disclosure if deemed suitable for carrying out the objects of the disclosure.

One of ordinary skill in the art will also readily appreciate that it is well within the ability of the ordinarily skilled artisan to modify one or more of the constituent parts for carrying out the various embodiments of the disclosure. Once armed with the present specification, routine experimentation is all that is needed to determine adjustments and modifications that will carry out the present disclosure.

The above embodiments are for illustrative purposes and are not intended to limit the scope of the disclosure or the adaptation of the features described herein. Those skilled in the art will also appreciate that various adaptations and modifications of the above-described preferred embodiments can be configured without departing from the scope and spirit of the disclosure. Therefore, it is to be understood that, within the scope of the appended claims, the invention may be practiced other than as specifically described.

What is claimed is:

1. A clamp guard for securing an electrical component, the clamp guard comprising:
a first body including,
a first upper end and a first lower end and a first axis extending between the first upper end and the first lower end, and
a first connection feature disposed proximate to the first upper end; and
a second body including,
a second upper end and a second lower end and a second axis extending between the second upper end and the second lower end, and
a second connection feature disposed proximate to the second upper end;
wherein the first connection feature is connected to the second connection feature along a pivot axis, the pivot axis is oriented at an oblique angle relative to the first axis and the second axis; and
wherein the first body is configured to pivot relative to the second body about the pivot axis between an open position and a closed position.

2. The clamp guard of claim 1, wherein the first body includes a female connection feature and the second body includes a male connection feature, wherein the male connection feature is configured to be removable received within the female connection feature to secure the first body and the second body in the closed position.

3. The clamp guard of claim 1 wherein,
the first upper end includes a first plurality of flexible fingers;
the second upper end includes a second plurality of flexible fingers;
the first plurality of flexible fingers and the second plurality of flexible fingers are configured to permit a conductor to egress a cavity of the clamp guard when the first plurality of flexible fingers and the second plurality of flexible fingers are interlaced in the closed position; and
the first body is configured to move about the pivot axis while the conductor egresses the cavity.

4. The clamp guard of claim wherein,
a first plurality of flexible fingers extends between the first upper end and the first lower end;
a second plurality of flexible fingers extends between the second upper end and the second lower end;
the first plurality of flexible fingers and the second plurality of flexible fingers are configured to permit a conductor to egress a cavity of the clamp guard when the first plurality of flexible fingers and the second plurality of flexible fingers are interlaced in the closed position; and
the first body is configured to move about the pivot axis while the conductor egresses the cavity.

5. The clamp guard of claim 1, wherein,
the first lower end includes a first plurality of flexible fingers arranged in a first curved pattern;
the second lower end includes a second plurality of flexible fingers arranged in a second curved pattern; and
the first curved pattern and the second curved pattern form an enclosed perimeter in the closed position.

6. The clamp guard of claim 5, wherein at least one flexible finger of the first plurality of flexible fingers is formed as a cantilever member with a fixed end and a free end, and wherein the free end is curved relative to the fixed end toward the first upper end.

7. The clamp guard of claim 1, wherein the first connection feature is removably connected to the second connection feature with a snap fit.

8. The clamp guard of claim 1, wherein the first body is movable relative to the second body by at least 180 degrees between the open position and the closed position.

9.-15. (canceled)

16. A clamp guard for securing an electrical component, the clamp guard comprising:
a first body including,
a first upper end, a first lower end, and a first edge extending between the first upper edge and first lower edge,
a first cavity configured to at least partially receive an electrical device, and
a first connection feature disposed proximate to the first upper end; and
a second body including,
a second upper end, a second lower end, and a second edge extending between the second upper edge and second lower edge,
a second cavity configured to at least partially receive the electrical device, and
a second connection feature disposed proximate to the second upper end;
wherein the first body is configured to pivot about a pivot axis relative to the second body between an open position and a closed position, the pivot axis is oriented at an oblique angle relative to the first edge and the second edge in the closed position;
wherein the first connection feature is configured to engage the second connection feature to selectively secure the first body and the second body in the closed position.

17. The clamp guard of claim 16, wherein,
the first edge includes a first plurality of flexible fingers; and
the second edge includes a second plurality of flexible fingers,
wherein the first plurality of fingers and the second plurality of fingers are configured to be interlaced in the closed position.

18. The clamp guard of claim 16, wherein,
the first connection feature includes an elongated body having a protrusion; and
the second connection feature includes an opening; and
wherein the first connection feature is configured to engage the second connection feature where the protrusion is received through the opening.

19. The clamp guard of claim 18, wherein the first connection feature is configured to flex to decrease a width of the elongated body and permit a withdrawal of the first connection feature from the opening.

20. The clamp guard of claim 16, wherein,
a first pivot connection extends from the first body at a first angle; and
the first connection feature extends from the first body at a second angle; and
wherein the first angle is equal to the second angle.

21. A method for securing a clamp guard to an electrical component, the method comprising:
connecting a first connection feature of a first body to a second connection feature of a second body with a snap fit;
pivoting the first connection feature relative to the second connection feature about a pivot axis to an open position to at least partially expose a first cavity of the first body and a second cavity of the second body;
positioning the electrical component within the second cavity, wherein the electrical component extends along a component axis perpendicular to an insertion axis and obliquely oriented with respect to the pivot axis;
pivoting the first body relative to the second body about the pivot axis to a closed position, wherein the electrical component is at least partially received within the first cavity and the second cavity.

22. The method of claim 21, further comprising positioning the electrical component at least partially through a second plurality of fingers that extend from the second body, and wherein a first plurality of fingers that extend from the first body are configured to interlace with the second plurality of fingers when the first body pivots to the closed position.

23. The method of claim 22, wherein the first plurality of fingers is disposed proximate to an upper end of the first body, wherein the second plurality of fingers is disposed proximate to an upper end of the second body, and wherein the pivot axis is disposed at the upper end of the first body and the upper end of the second body.

24. The method of claim 21, further comprising removably connecting a first connection feature of the first body to a second connection feature of the second body to removably secure the first body and the second body in the closed position.

25. The method of claim 24, wherein the first connection feature is an elongated member with a protrusion and the second connection feature includes an opening.

26. The method of claim 21, further comprising pivoting the first body at least 180 degrees relative to the second body between the open position and the closed position.

27. The method of claim 21, further comprising pivoting the first body relative to the second body from the closed position into the open position to access the electrical component, wherein the first body remains connected to the second body during the pivoting movement.
